(19) United States
(12) Patent Application Publication
(10) Pub. No.: US 2026/0005977 A1
(43) Pub. Date: Jan. 1, 2026

(54) DEVICES AND METHODS FOR PACKET ORDERING IN DYNAMICALLY CONNECTED TRANSPORT PROTOCOLS

(71) Applicant: MELLANOX TECHNOLOGIES, LTD., Yokneam (IL)

(72) Inventors: Yamin FRIEDMAN, Jerusalem (IL); Idan BURSTEIN, Carmiel (IL); Diego CRUPNICOFF, Buenos Aires (AR); Roee MOYAL, Yoqneam Ilit (IL)

(73) Assignee: MELLANOX TECHNOLOGIES, LTD., Yokneam (IL)

(21) Appl. No.: 18/756,760

(22) Filed: Jun. 27, 2024

(51) Int. Cl. H04L 47/52; H04L 47/62

(52) U.S. Cl. CPC H04L 47/522; H04L 47/624

(57) ABSTRACT

Devices, methods, and computer program products are provided for addressing out of order packet delivery in dynamically connected (DC) transport protocols. An example method includes receiving, by a destination device, a plurality of data packets from a transmitting device where each of the plurality of data packets includes a connect header associated with DC establishment and establishing a DC between the destination device and the transmitting device based on one or more of the data packets of the plurality of data packets. The plurality of data packets include a first set of data packets received by the destination device prior to establishment of the DC, and a second set of data packets received by the destination device after establishment of the DC. The establishment of the DC occurs irrespective of an order in which each of the plurality of data packets are received by the destination device.

### TECHNOLOGICAL FIELD

Embodiments of the present disclosure relate generally to data communication systems, and, more particularly, to data transport protocols used in dynamically connected communication systems.

### BACKGROUND

Datacenters, high performance computing clusters, communication networks, and/or the like are often formed of various computing components (e.g., hosts, nodes, servers, racks, switches, etc.). For example, a communication network may be formed of a plurality of nodes, the connections of which may be governed by various data transport protocols. Through applied effort, ingenuity, and innovation, many of the problems associated with conventional networking and computing systems have been solved by developing solutions that are included in embodiments of the present disclosure, many examples of which are described in detail herein.

### BRIEF SUMMARY

Embodiments of the present disclosure provide for devices, methods, and computer program products for addressing out of order packet delivery in dynamically connected (DC) transport protocols. An example computer-implemented method includes receiving, by a destination device, a plurality of data packets from a transmitting device where each of the plurality of data packets includes a connect header associated with dynamic connection (DC) establishment. The method further includes establishing a dynamic connection (DC) between the destination device and the transmitting device based on one or more of the data packets of the plurality of data packets. The establishment of the dynamic connection (DC) may occur irrespective of an order in which each of the plurality of data packets are received by the destination device.

In some embodiments, the plurality of data packets may further include a first set of data packets received by the destination device prior to establishment of the dynamic connection (DC) between the destination device and the transmitting device. The plurality of data packets may further include a second set of data packets received by the destination device after establishment of the dynamic connection (DC) between the destination device and the transmitting device.

In some further embodiments, the first set of data packets may further include a first data packet including one or more instructions for establishing the dynamic connection (DC) between the destination device and the transmitting device.

In some further embodiments, the connect header for each of the data packets of the first set of data packets includes one or more data entries for establishing the dynamic connection (DC).

Additionally or alternatively, in some embodiments, the connect header of the first data packet may include one or more data entries that identify an initial packet sequence number (PSN) associated with the dynamic connection (DC).

In other embodiments, each respective connect header of the data packets forming the first set of data packets may further include a packet sequence number (PSN) defining a position at which the respective packet is to be executed by the destination device.

In some further embodiments, the dynamic connection (DC) between the destination device and the transmitting device may be associated with an initial packet sequence number (PSN), such that the destination device may order each of the plurality of data packets relative to the initial packet sequence number (PSN).

Additionally or alternatively, in some further embodiments, the dynamic connection (DC) between the destination device and the transmitting device may be established in the absence of a connect packet transmission.

An example computing device may include a non-transitory storage device and a processor coupled to the non-transitory storage device. The processor may be configured to receive a plurality of data packets from a transmitting device where each of the plurality of data packets may include a connect header associated with dynamic connection (DC) establishment and establishing a dynamic connection (DC) between the computing device and the transmitting device based on one or more of the data packets of the plurality of data packets. Establishment of the dynamic connection (DC) may occur irrespective of an order in which each of the plurality of data packets are received by the computing device.

An example computer program product may include at least one non-transitory computer-readable storage medium having computer program code thereon that may, in execution with at least one processor, configure the computer program product for receiving a plurality of data packets from a transmitting device where each of the plurality of data packets may include a connect header associated with dynamic connection (DC) establishment and establishing a dynamic connection (DC) between a destination device and the transmitting device based on one or more of the data packets of the plurality of data packets. Establishment of the dynamic connection (DC) may occur irrespective of an order in which each of the plurality of data packets are received by the destination device.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings. The components illustrated in the figures may or may not be present in certain embodiments described herein. Some embodiments may include fewer (or more) components than those shown in the figures.

FIG. 1 illustrates an example of out of order packet delivery in dynamically connected (DC) transports addressed by one or more embodiments of the present disclosure;

FIG. 2 illustrates an example communication network for implementing one or more embodiments of the present disclosure;

FIG. 3 illustrates a block diagram of example destination device circuitry that may be specifically configured in accordance with an example embodiment of the present disclosure;

FIG. 4 illustrates a flowchart of an example method for addressing out of order packet delivery in dynamically connected (DC) transports, in accordance with some embodiments of the present disclosure;

FIG. 5 illustrates a flowchart of an example connect packet-based method for addressing out of order packet delivery in dynamically connected (DC) transports, in accordance with some embodiments of the present disclosure; and

FIG. 6 illustrates a flowchart of an example initial packet sequence number (PSN)-based method for addressing out of order packet delivery in dynamically connected (DC) transports, in accordance with some embodiments of the present disclosure.

### DETAILED DESCRIPTION

### Overview

Various embodiments of the present disclosure will now be described more fully hereinafter with reference to the accompanying drawings in which some but not all embodiments are shown. Indeed, the present disclosure may be embodied in many different forms and should not be construed as limited to the embodiments set forth herein; rather these embodiments are provided so that this disclosure will satisfy applicable legal requirements. Like reference numerals refer to like elements throughout.

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein as receiving data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein as sending data to another computing device, it will be appreciated that the data may be sent directly to another computing device or may be sent indirectly via one or more intermediary computing devices, such as, for example, one or more servers, relays, routers, network access points, base stations, hosts, and/or the like.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

The terms “illustrative,” “exemplary,” and “example” as may be used herein are not provided to convey any qualitative assessment, but instead merely to convey an illustration of an example. Thus, use of any such terms should not be taken to limit the spirit and scope of embodiments of the present disclosure. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

As described above, datacenters, high performance computing clusters, communication networks, and/or the like are often formed of various computing components (e.g., hosts, nodes, servers, racks, switches, etc.). For example, a communication network may be formed of a plurality of nodes, the connections of which may be governed by various data transport protocols. For example, data transport protocols may be used to provide delivery guarantees and, in traditional systems, a connection state on both sides of the network (e.g., between transmitting and destination devices) may be used for this guarantee. Such a connection state, however, requires allocated memory, and the connection establishment is completed outside of the data path to ensure that the connection is established reliably before data is sent. When attempting to scale device communication, such as in a scaling network of thousands of nodes each having hundreds of processes, the state required for connected transports often becomes prohibitively expensive.

As such, dynamically connected (DC) data transport protocols may be leveraged. As would be evident to one of ordinary skill in the art, a DC data transport protocol may refer to a data transport that does not maintain any connection state while traffic (e.g., data packets) is not being sent. In a DC transport, a connection is established (e.g., between a destination and a transmitting device) in-line with the first data packet that is transmitted (e.g., by the transmitting device) and then removed by sending a data packet (e.g., by the transmitting device) indicating that all the data was successfully transmitted and received. Because the destination device in a conventional DC transport protocol does not maintain a permanent state, packets that arrive before the connection is established are dropped as the destination device lacks an ability to recognize these packets.

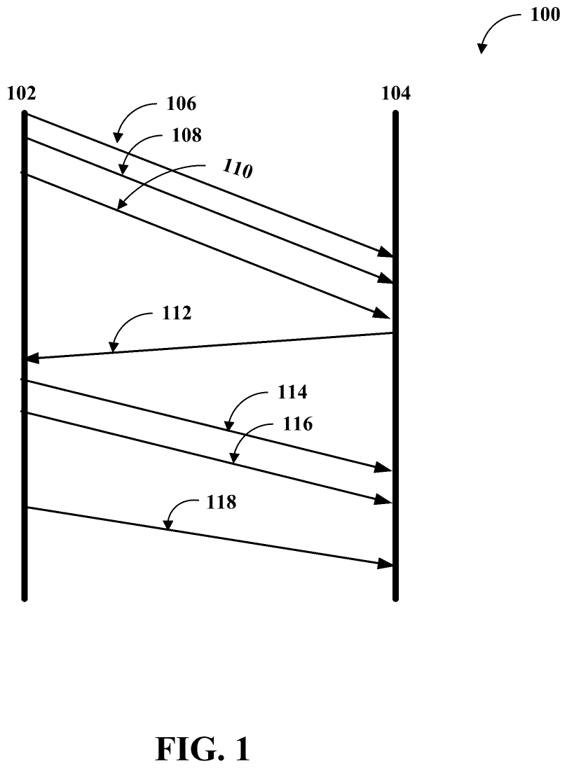

As shown in FIG. 1, an example of out of order packet delivery in dynamically connected (DC) transports 100 is illustrated. As shown, a transmitting device 102 may attempt to establish communication with a destination device 104 such that data packets may be transmitted therebetween. The transmitting device 102 may leverage a DC transport by transmitting a request for the DC connection 106 alongside a data packet 108, such as via a remote direct memory access (RDMA) transmission. The transmitting device 102 may continue to transmit a plurality of data packets associated with this dynamic connection (e.g., the connection intended to be established by data packet 106). For example, data packet 110, data packet 114, and data packet 116 may be transmitted by the transmitting device 102 and received by the destination device 104 via the DC. In other words, each of packets 106, 108, 110, 114, and 116 may be hereinafter referred to as a plurality of data packets received by the destination device 104.

The dynamic connection between the transmitting device 102 and the destination device 104 may be reliability established, such as via receipt of a data transmission 112 by the transmitting device 102 from the destination device 104. The reliable establishment of the DC between the transmitting device 102 and destination device 104, however, may occur at a time that is amongst (e.g., in the midst of) the times at which the plurality of data packets 110, 114, 116, etc. are received by the destination device 104. As described hereinafter, the plurality of data packets may include a first set of data packets received by the destination device 104 prior to establishment of the dynamic connection (DC) between the destination device 104 and the transmitting device 102. Furthermore, the plurality of data packets may include a second set of data packets received by the destination device 104 after establishment of the dynamic connection (DC) between the destination device 104 and the transmitting device 102. A data packet 118, for example, ending the dynamic connection may be received by the destination device 104 from the transmitting device 102.

As described above, because the destination device 104 in a conventional DC transport protocol does not maintain a permanent state, packets that arrive before the dynamic connection is established (e.g., data packet 110 or any data packet of the first set of data packets) are dropped as the destination device 104 lacks an ability to recognize these packets. Furthermore, as various packet spreading mechanisms are used as part of DC protocols, any of the plurality of packets that are received out of order (e.g., any order other than the order intended by transmitting device 102) in a conventional DC implementation may be executed or otherwise acted on by the destination device 104 in an incorrect order. Said differently, conventional DC-based systems lack the ability to correctly order data packets that are received out of order.

In order to solve these problems and others, the embodiments of the present disclosure provide a method for addressing out of order packet delivery in DC transport protocols by leveraging connect headers, such that each data packet includes the data that is necessary to establish the connection as part of a common connection. In some embodiments, this connect header is added to all packets that are sent before connection establishment, and the connect packet is used to indicate the first packet sequence number (PSN) of the connection. In other embodiments, the need for a special connect packet is removed, but the connection is required to start with a PSN 0 (or other known value) so that the destination device may unambiguously determine the first packet of the connection. In either embodiment, the packet(s) that are received first are used to establish the dynamic connection, and all other packets for the particular flow are associated on arrival with the correct connection. In doing so, the embodiments of the present disclosure may operate to gain the network scaling benefits of DC transport protocols while addressing order of order packet delivery that is often prevalent in conventional implementations.

### Example Communication Network

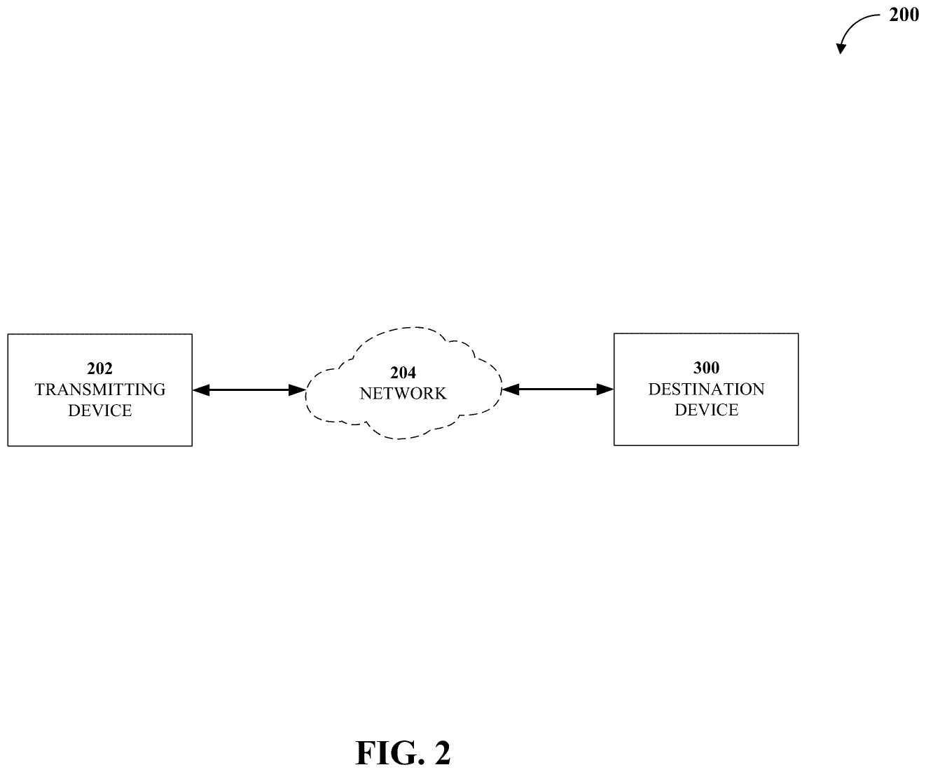

FIG. 2 illustrates an example communication network 200 (e.g., network 200) as an example system for addressing out of order packet delivery in dynamically connected (DC) transport protocols. It will be appreciated that the network 200 is provided as an example of an embodiment(s) and should not be construed to narrow the scope or spirit of the disclosure. The depicted network 200 of FIG. 2 may include a destination device 300 (e.g., a receiving device, a responder device, etc.) capable of communicating with other devices in the network 200 via a DC data transport protocol as described herein. The destination device 300 may be communicatively connected to one or more transmitting devices 202 by a communication network 204. Although illustrated in FIG. 2 as a single destination device 300 in the network 200, the present disclosure contemplates that the network 200 may include any number of destination devices 300. Similarly, although illustrated in FIG. 2 as a single transmitting device 202 in the network 200, the present disclosure contemplates that the network 200 may include any number of transmitting devices 202. Furthermore, the present disclosure contemplates that any device, node, etc. within the network 200 may operate as a destination device 300 or transmitting device 202. For example, the destination device 300 may, in some instances, perform the operations described herein with reference to the transmitting device 202, and/or the transmitting device 202 may, in some instances, perform the operations described herein with reference to the destination device 300.

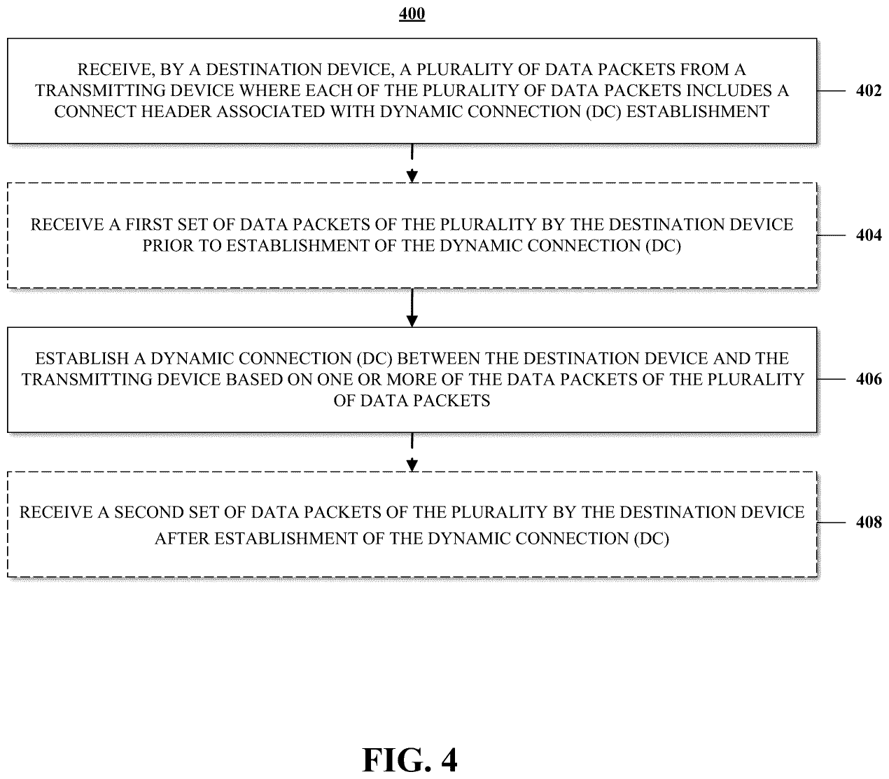

Although described hereinafter with reference to a destination device 300, the present disclosure contemplates that the operations described hereafter with reference to FIGS. 4-6 may be performed by any computing device, system orchestrator, central processing unit (CPU), graphics processing unit (GPU), data processing unit (DPU), and/or the like that may operate as a node in the network 200. Furthermore, although illustrated as a single device (e.g., destination device 300), the present disclosure contemplates that any number of distributed components may collectively be used to perform the operations described herein. The destination device 300 may be embodied in an entirely hardware embodiment, an entirely computer program product embodiment, an entirely firmware embodiment (e.g., application-specific integrated circuit, field-programmable gate array, etc.), and/or an embodiment that comprises a combination of computer program products, hardware, and firmware.

The network 200 may further include a transmitting device 202 as described above. The transmitting device may similarly include any computing device, system orchestrator, central processing unit (CPU), graphics processing unit (GPU), data processing unit (DPU), and/or the like that may operate as a node in the network 200. Furthermore, although illustrated as a single device (e.g., transmitting device 202), the present disclosure contemplates that any number of distributed components may collectively be used to perform the operations described herein. The transmitting device 202 may also be embodied in an entirely hardware embodiment, an entirely computer program product embodiment, an entirely firmware embodiment (e.g., application-specific integrated circuit, field-programmable gate array, etc.), and/or an embodiment that comprises a combination of computer program products, hardware, and firmware.

The communication network 204 may be any means including hardware, software, devices, or circuitry that is configured to support the transmission of computer messages between system nodes. For example, the communication network 204 may be formed of components supporting wired transmission protocols, such as, digital subscriber line (DSL), Ethernet, fiber distributed data interface (FDDI), or any other wired transmission protocol obvious to a person of ordinary skill in the art. The communication network 204 may also be comprised of components supporting wireless transmission protocols, such as Bluetooth, IEEE 802.11 (Wi-Fi), or other wireless protocols obvious to a person of ordinary skill in the art. In addition, the communication network 204 may be formed of components supporting a standard communication bus, such as, a Peripheral Component Interconnect (PCI), PCI Express (PCIe or PCI-e), PCI extended (PCI-X), Accelerated Graphics Port (AGP), or other similar high-speed communication connection. Further, the communication network 204 may be comprised of any combination of the above mentioned protocols. As described herein, the devices 202, 300 may communicate via a dynamically connected (DC) data transport protocol. As such, the present disclosure contemplates that the communication network 204 described herein may be configured to enable DC data transport protocols.

### Example Destination Device Circuitry

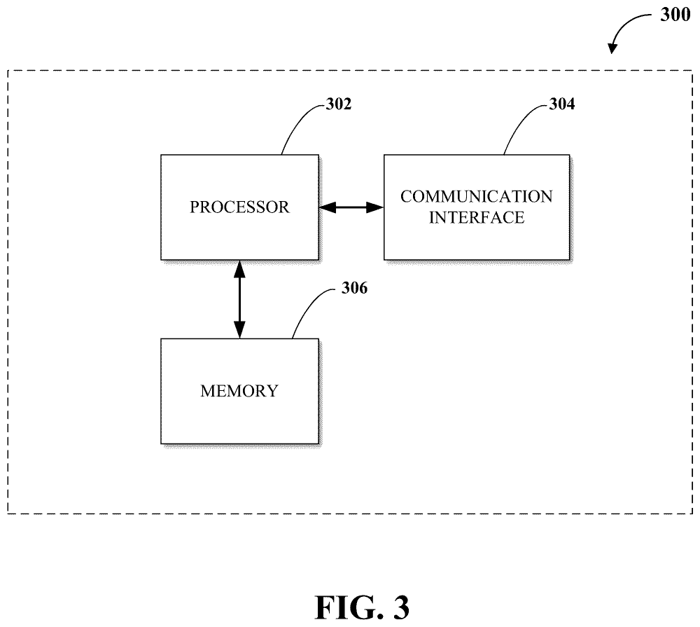

With reference to FIG. 3, example circuitry components of the destination device 300 are illustrated that may, alone or in combination with any of the components described herein, be configured to perform the operations described herein with reference to FIGS. 4-6. As shown, the destination device 300 may include, be associated with or be in communication with processor 302, a memory 306, and a communication interface 304. The processor 302 may be in communication with the memory 306 via a bus for passing information among components of the destination device 300. The memory 306 may be non-transitory and may include, for example, one or more volatile and/or non-volatile memories. In other words, for example, the memory 306 may be an electronic storage device (e.g., a computer readable storage medium) comprising gates configured to store data (e.g., bits) that may be retrievable by a machine (e.g., a computing device like the processing circuitry). The memory 306 may be configured to store information, data, content, applications, instructions, or the like for enabling the apparatus to carry out various functions in accordance with an example embodiment of the present disclosure. For example, the memory 306 could be configured to buffer input data for processing by the processor 302. Additionally or alternatively, the memory 306 could be configured to store instructions for execution by the processor 302.

The destination device 300 (e.g., example apparatus/computing device of the present disclosure) may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processor 302 may be embodied in a number of different ways. For example, the processor 302 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processor 302 may be configured to execute instructions stored in the memory 306 or otherwise accessible to the processor 302. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processor 302 is embodied as an executor of instructions, the instructions may specifically configure the processor to perform the algorithms and/or operations described herein when the instructions are executed. However, in some cases, the processor 302 may be a processor of a specific device configured to employ an embodiment of the present disclosure by further configuration of the processing circuitry by instructions for performing the algorithms and/or operations described herein. The processor 302 may include, among other things, a clock, an arithmetic logic unit (ALU) and logic gates configured to support operation of the processing circuitry.

The communication interface 304 may be any means such as a device or circuitry embodied in either hardware or a combination of hardware and software that is configured to receive and/or transmit data, including media content in the form of video or image files, one or more audio tracks or the like. In this regard, the communication interface 304 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms. As described above, the destination device 300 may be configured to communication with the transmitting device 202 via a DC data transport protocol. As such, the communication interface 304 of the destination device 300 may include any circuitry components, hardware, etc. required to establish a connection with the transmitting device via such a DC data transport protocol.

Although described herein with reference to the circuitry components of the destination device 300 in FIG. 3, the present disclosure contemplates that any device within the network 200 may include the circuitry components of FIG. 3. As described above, the destination device 300 may, in some instances, perform the operations described herein with reference to the transmitting device 202, and/or the transmitting device 202 may, in some instances, perform the operations described herein with reference to the destination device 300. As such, the transmitting device 202 may similarly include a processor, memory, communication interface, and/or the like for performing the operations described herein with reference to the destination device.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the destination device 300 may provide or supplement the functionality of particular circuitry.

### Example Methods for Addressing Out of Order Packet Delivery

FIG. 4 illustrates a flowchart containing a series of operations for addressing out of order packet delivery in dynamically connected (DC) transport protocols (e.g., method 400). The operations illustrated in FIG. 4 may, for example, be performed by, with the assistance of, and/or under the control of an apparatus (e.g., destination device 300), as described above. In this regard, performance of the operations may invoke one or more of processor 302, memory 306, and/or communication interface 304.

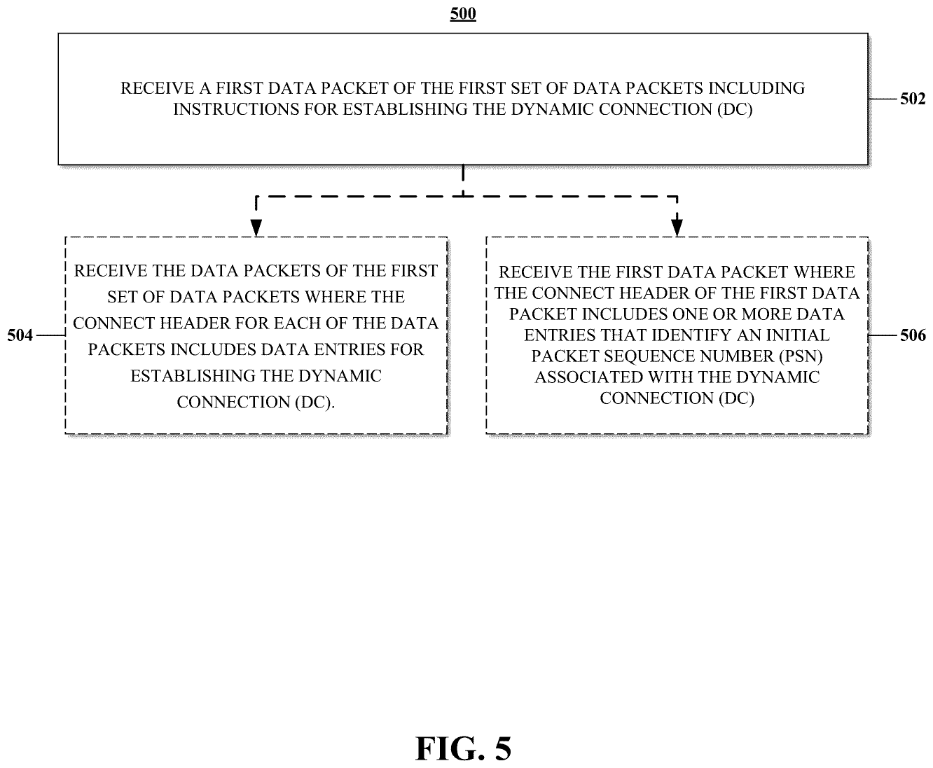

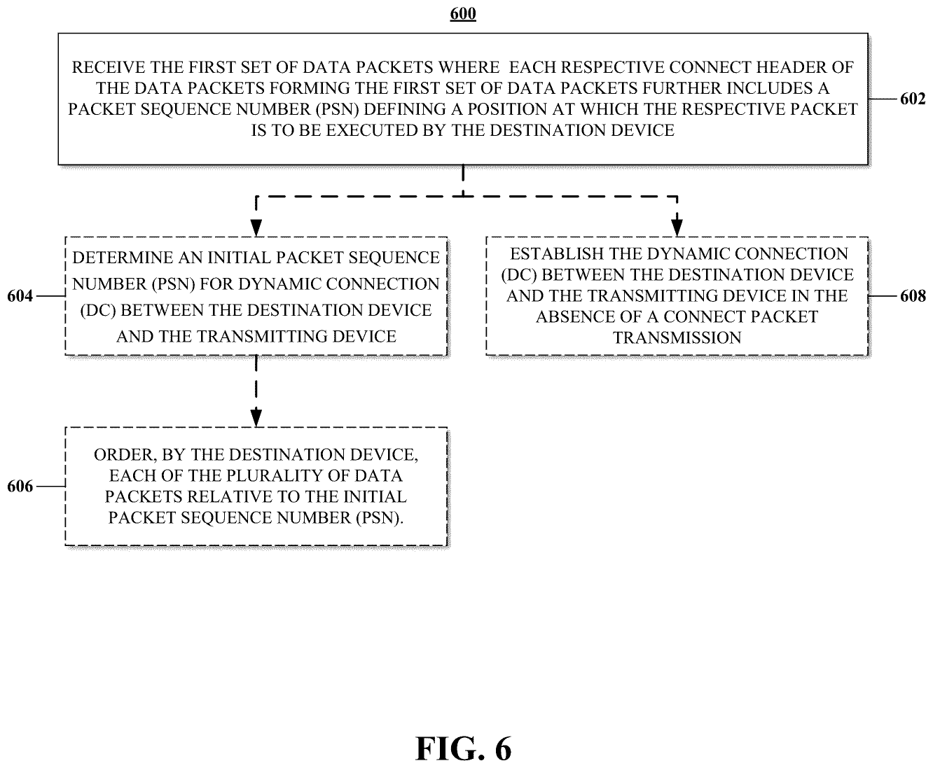

As shown in operation 402, the apparatus (e.g., destination device 300) includes means, such as communication interface 304, or the like, for receiving, by the destination device 300, a plurality of data packets from a transmitting device 202. As described above with reference to FIG. 1, the transmitting device 202 may transmit any number of data packets that are intended to be associated with the same dynamic connection with the destination device 300. Unlike data packets in conventional DC transport protocols, each of the plurality of data packets include or otherwise define a connect header associated with dynamic connection (DC) establishment. As described hereinafter with reference to FIGS. 5, the connect header that is defined by each of the data packets transmitted by the transmitting device 202 and received by the destination device 300 may include data for identifying an initial packet sequence number (PSN) (e.g., a connect packet-based implementation) associated with the dynamic connection (DC). As described hereinafter with reference to FIG. 6, the connect header of the data packets, such as the data packets forming the first set of data packets as described hereinafter, may also include a packet sequence number (PSN) defining a position at which the respective packet is to be executed by the destination device 300.

In some embodiments, the plurality of data packets may be transmitted via a remote direct memory access (RDMA) based communication. For example, the transmitting device 202 be configured to, in transmitting data packets, directly access the memory of the destination device 300 without involving the operating system of the destination device 300, and vice versa. In any embodiment described herein, each of the plurality of data packets received by the destination device 300 regardless of the set (e.g., first set or second set) to which the particular data packet belongs may include any information required to be identified by the destination device 300 as belonging to the particular dynamic connection. By way of a non-limiting example, the plurality of data packets may include any identifier (e.g., a queue pair (QP) number, a transaction ID, an initiator ID, a responder ID, and/or the like) associated with the transmitting device 202 and/or the destination device 300. Furthermore, the present disclosure contemplates that the information required to determine that the data packets belong to the same connection may include any data for distinguishing between source, such as in instances in which different transmitting devices transmit data packets to the same destination device 300 (e.g., same destination address).

As shown in operation 404, the apparatus (e.g., destination device 300) includes means, such as communication interface 304, or the like, for receiving, by the destination device 300, a first set of data packets prior to establishment of the dynamic connection (DC) between the destination device 300 and the transmitting device 202. As described above with reference to FIG. 1, the destination device 300 may receive a plurality of data packets, each of which include the connect header described hereinafter, at various times. In some instances, a portion or subset of the plurality of data packets received by the destination device 300 from the transmitting device 202 may be received prior to establishment of the DC between these devices 300, 202. As would be evident to one of ordinary skill in the art in light of the present disclosure, the first set of data packets may refer to any data packet that would, in a conventional DC implementation, normally be discarded. In the embodiments of the present disclosure, however, the first set of data packets are not only retained by the destination device 300 but able to be ordered by the destination device, due at least in part to the data contained in the connect headers for these data packets as described hereinafter.

Thereafter, as shown in operation 406, the apparatus (e.g., destination device 300) includes means, such as processor 302, or the like, for establishing a dynamic connection (DC) between the destination device 300 and the transmitting device 202 based on one or more of the data packets of the plurality of data packets. As described above, a DC data transport protocol may refer to a data transport that does not maintain any connection state while traffic (e.g., data packets) is not being sent. In a DC transport, a connection may be established (e.g., between a destination and a transmitting device 202) in-line with the first data packet that is transmitted (e.g., by the transmitting device) and then removed by sending a data packet (e.g., by the transmitting device 202) indicating that all the data was successfully transmitted and received. In some embodiments of the present disclosure, each of the data packets received by the destination device 300 from the transmitting device 202 at operations 402-404 may include the data entries (e.g., in number, type, etc.) required for establishing a DC transport protocol based connection. Given that the first set of data packets of the plurality of data packets refer to data packets that are received prior to establishment of the DC between the destination device 300 and the transmitting device 202, each of the data packets in the first set may, in some embodiments, include any and all necessary data entries required for establishing a DC transport protocol based connection. By way of a non-limiting example, each of the data packets in the first set may include any applicable keys (e.g., encryption related or otherwise) for verifying a particular connection.

The present disclosure contemplates that, based on the nature of the network 200, the devices 202, 300, and/or the like, the data required to establish a DC transport protocol based connection may vary. At operation 406, the present disclosure therefore contemplates that at least one or more of the data packets of the first set include the data entries that, at least in part, are required for establishing the DC transport protocol based connection with at least the transmitting device 202. Said differently, the connect header for each of the data packets of the first set of data packets may include one or more data entries for establishing the dynamic connection (DC). As described hereinafter with reference to FIG. 5, in some embodiments, at least a first data packet (e.g., a connect packet) may be received by the destination device 300 from the transmitting device 202. In such an embodiment, the first data packet (e.g., the connect packet) may include one or more instructions for establishing the dynamic connection (DC) between the destination device 300 and the transmitting device 202. In such an embodiment, the connect header of the first data packet may include one or more data entries that identify an initial packet sequence number (PSN) associated with the dynamic connection (DC). Although described herein with reference to an example first data packet, the present disclosure contemplates that, in the embodiment of FIG. 5, any particular data packet received by the destination device 300 may operate as the connect packet (e.g., the packet providing instructions to establish a dynamic connection).

As shown in operation 408, the apparatus (e.g., destination device 300) includes means, such as communication interface 304, or the like, for receiving, by the destination device 300, a second set of data packets after establishment of the dynamic connection (DC) between the destination device 300 and the transmitting device 202. As described above with reference to FIG. 1, the destination device 300 may receive a plurality of data packets, each of which include the connect header described hereinafter, at various times. In some instances, a portion or subset of the plurality of data packets received by the destination device 300 from the transmitting device 202 may be received after establishment of the DC between these device 300, 202. As would be evident to one of ordinary skill in the art in light of the present disclosure, the second set of data packets may, in some embodiments, not require data entries (e.g., in number, type, etc.) required for establishing a DC transport protocol based connection given that such a DC is already established at the time at which the second set of data packets are received.

The destination device 300 may be configured to establish the dynamic connection (DC) between the destination device 300 and the transmitting device 202 irrespective of an order in which each of the plurality of data packets are received by the destination device 300. As described above, because the destination device 300 in a conventional DC transport protocol does not maintain a permanent state, packets that arrive before the dynamic connection is established are dropped and packets that are received out of order may be executed by the destination device in an incorrect order (any order other than the order intended by transmitting device 102). The embodiments of the present disclosure address this ordering issue as described hereinafter. For example, as described with reference to FIG. 5, a first data packet (e.g., the connect packet) of the first set of data packets may also include one or more data entries (e.g., in the connect header) that identify an initial packet sequence number (PSN) associated with the dynamic connection (DC). In doing so, the PSN for every other data packet received by the destination device may be ordered relative to this initial PSN. By way of an additional example, as described with reference to FIG. 6, in some embodiments, each respective connect header of the data packets forming the first set of data packets further includes a packet sequence number (PSN) defining a position at which the respective packet is to be executed by the destination device 300. The DC between the destination device 300 and the transmitting device 202 may also be associated with an initial packet sequence number (PSN), such that the destination device 300 may order each of the plurality of data packets relative to the initial packet sequence number (PSN).

FIG. 5 illustrates a flowchart containing a series of operations for a connect packet-based method for addressing out of order packet delivery in dynamically connected (DC) transports (e.g., method 500). The operations illustrated in FIG. 5 may, for example, be performed by, with the assistance of, and/or under the control of an apparatus (e.g., destination device 300), as described above. In this regard, performance of the operations may invoke one or more of processor 302, memory 306, and/or communication interface 304.

As shown in operation 502, the apparatus (e.g., destination device 300) includes means, such as communication interface 304, or the like, for receiving a first data packet of the first set of data packets that includes one or more instructions for establishing the dynamic connection (DC) between the destination device 300 and the transmitting device 202. As described above, in some embodiments, a particular data packet received prior to establishment of the DC may operate as the connect packet in that such a packet includes instructions for establishing the DC between the destination device 300 and the transmitting device 202. In some embodiments, the first data packet (e.g., the connect packet) may further include data entries (e.g., in number, type, etc.) required for establishing a DC transport protocol based connection. Thereafter, in other embodiments, as shown in operation 504, the destination device may receive each of the data packets of the first set of data packets where the connect header for each of the data packets includes data entries for establishing the dynamic connection (DC). Said differently, in some embodiments, the establishment of the DC between the destination device 300 and the transmitting device 202 may be instructed by the first data packet (e.g., the connect packet), but the establishment of the DC may be based at least in part on the data entries of the connect header(s) of the data packets of the first set of data packets.

In some embodiments, as shown at operation 506, the apparatus (e.g., destination device 300) includes means, such as communication interface 304, or the like, for receiving the first data packet where the connect header of the first data packet includes one or more data entries that identify an initial packet sequence number (PSN) associated with the dynamic connection (DC). As described above, the first data packet may include instructions for establishing the DC and, as such, may operate as the first or initial data packet in the sequence (e.g., ordering) of data packets to be executed by the destination device 300. In such an embodiment, by assigning the first data packet the initial PSN (e.g., PSN 0 or the like), the PSN for every other data packet received by the destination device 300 may be ordered relative this initial PSN. For example, the connect header for each data packet received by the destination device 300 (e.g., at least the first set of data packets), the connect header may define an associated PSN defining a position at which the respective packet is to be executed by the destination device 300. This associated PSN for each data packet may be ordered relative to the initial PSN of the first data packet in order to ensure that the data packets are executed in the correct order.

FIG. 6 illustrates a flowchart containing a series of operations for an example initial packet sequence number (PSN)-based method for addressing out of order packet delivery in dynamically connected (DC) transports (e.g., method 600). The operations illustrated in FIG. 5 may, for example, be performed by, with the assistance of, and/or under the control of an apparatus (e.g., destination device 300), as described above. In this regard, performance of the operations may invoke one or more of processor 302, memory 306, and/or communication interface 304.

As shown in operation 602, the apparatus (e.g., destination device 300) includes means, such as communication interface 304, or the like, for receiving the first set of data packets where each respective connect header of the data packets forming the first set of data packets further includes a packet sequence number (PSN) defining a position at which the respective packet is to be executed by the destination device 300. In the embodiment of FIG. 6, a connect packet is not used to instruct the establishment of the DC between the destination device 300 and the transmitting device 202. In such an embodiment, each of the data packets of the first set of data packets may include data entries (e.g., in number, type, etc.) required for establishing a DC transport protocol based connection. In the absence of a connect packet (e.g., the example first data packet of FIG. 5) that sets the initial PSN for the dynamic connection, the dynamic connection (DC) between the destination device 300 and the transmitting device 202 may be associated with an initial PSN. In other words, without a connect packet to instruct the destination device 300 of the initial PSN value, the destination device 300 may receive a plurality of data packets each having respective PSN values without an initial PSN value against which to order.

As such, at operations 604 and 606, the apparatus (e.g., destination device 300) includes means, such as processor 302, or the like, for determining an initial packet sequence number (PSN) for the dynamic connection (DC) between the destination device 300 and the transmitting device 202 and ordering each of the plurality of data packets relative to the initial packet sequence number (PSN). The present disclosure contemplates that the destination device 300 may determine the initial PSN for the dynamic connection with the transmitting device 202 via any mechanism, technique, etc. For example, in some embodiments, the connect header of at least one of the data packets received by the destination device 300 from the transmitting device 202 may provide the initial PSN for the DC. In other embodiments, the transmitting device 202 may be associated with a default or standard initial PSN, such that, for all DCs associated with the transmitting device 202, the initial PSN is determined to be the default or standard initial PSN for the transmitting device 202. By way of an additional example, the destination device 300 and/or the transmitting device 202 may be communicably coupled with one or more other computing devices (not shown) that may be configured to provide initial PSNs to one or more devices of the network 200. Similar to the operations of FIG. 5, the destination device may order each of the plurality of data packets relative to the initial packet sequence number (PSN). As shown in operation 608, the apparatus (e.g., destination device 300) includes means, such as processor 302, or the like, for therefore establishing the dynamic connection (DC) between the destination device 300 and the transmitting device 202 in the absence of a connect packet transmission.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. The disclosed embodiments relate primarily to a network interface environment, however, one skilled in the art may recognize that such principles may be applied to any scheduler receiving commands and/or transactions and having access to two or more processing cores. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. A computer-implemented method comprising:
receiving, by a destination device, a plurality of data packets from a transmitting device, wherein each of the plurality of data packets comprises a connect header associated with dynamic connection (DC) establishment; and
establishing a dynamic connection (DC) between the destination device and the transmitting device based on one or more of the data packets of the plurality of data packets,
wherein establishment of the dynamic connection (DC) occurs irrespective of an order in which each of the plurality of data packets are received by the destination device.

2. The computer-implemented method according to claim 1, wherein the plurality of data packets further comprise:
a first set of data packets received by the destination device prior to establishment of the dynamic connection (DC) between the destination device and the transmitting device; and
a second set of data packets received by the destination device after establishment of the dynamic connection (DC) between the destination device and the transmitting device.

3. The computer-implemented method according to claim 2, wherein the first set of data packets further comprise a first data packet comprising one or more instructions for establishing the dynamic connection (DC) between the destination device and the transmitting device.

4. The computer-implemented method according to claim 3, wherein the connect header for each of the data packets of the first set of data packets comprises one or more data entries for establishing the dynamic connection (DC).

5. The computer-implemented method according to claim 3, wherein the connect header of the first data packet comprises one or more data entries that identify an initial packet sequence number (PSN) associated with the dynamic connection (DC).

6. The computer-implemented method according to claim 2, wherein each respective connect header of the data packets forming the first set of data packets further comprises a packet sequence number (PSN) defining a position at which the respective packet is to be executed by the destination device.

7. The computer-implemented method according to claim 6, wherein the dynamic connection (DC) between the destination device and the transmitting device is associated with an initial packet sequence number (PSN), such that the destination device may order each of the plurality of data packets relative to the initial packet sequence number (PSN).

8. The computer-implemented method according to claim 6, wherein the dynamic connection (DC) between the destination device and the transmitting device is established in the absence of a connect packet transmission.

9. A computing device comprising:
a non-transitory storage device; and
a processor coupled to the non-transitory storage device, wherein the processor is configured to:
receive a plurality of data packets from a transmitting device, wherein each of the plurality of data packets comprises a connect header associated with dynamic connection (DC) establishment; and
establishing a dynamic connection (DC) between the computing device and the transmitting device based on one or more of the data packets of the plurality of data packets,
wherein establishment of the dynamic connection (DC) occurs irrespective of an order in which each of the plurality of data packets are received by the computing device.

10. The computing device according to claim 9, wherein the plurality of data packets further comprise:
a first set of data packets received by the computing device prior to establishment of the dynamic connection (DC) between the computing device and the transmitting device; and
a second set of data packets received by the computing device after establishment of the dynamic connection (DC) between the computing device and the transmitting device.

11. The computing device according to claim 10, wherein the first set of data packets further comprise a first data packet comprising one or more instructions for establishing the dynamic connection (DC) between the computing device and the transmitting device.

12. The computing device according to claim 11, wherein the connect header for each of the data packets of the first set of data packets comprises one or more data entries for establishing the dynamic connection (DC).

13. The computing device according to claim 11, wherein the connect header of the first data packet comprises one or more data entries that identify an initial packet sequence number (PSN) associated with the dynamic connection (DC).

14. The computing device according to claim 10, wherein each respective connect header of the data packets forming the first set of data packets further comprises a packet sequence number (PSN) defining a position at which the respective packet is to be executed by the computing device.

15. The computing device according to claim 14, wherein the dynamic connection (DC) between the computing device and the transmitting device is associated with an initial packet sequence number (PSN), such that the computing device may order each of the plurality of data packets relative to the initial packet sequence number (PSN).

16. The computing device according to claim 14, wherein the dynamic connection (DC) between the computing device and the transmitting device is established in the absence of a connect packet transmission.

17. A computer program product comprising at least one non-transitory computer-readable storage medium having computer program code thereon that, in execution with at least one processor, configures the computer program product for:
receiving a plurality of data packets from a transmitting device, wherein each of the plurality of data packets comprises a connect header associated with dynamic connection (DC) establishment; and
establishing a dynamic connection (DC) between a destination device and the transmitting device based on one or more of the data packets of the plurality of data packets,
wherein establishment of the dynamic connection (DC) occurs irrespective of an order in which each of the plurality of data packets are received by the destination device.

18. The computer program product according to claim 17, wherein the plurality of data packets further comprise:
a first set of data packets received by the computing device prior to establishment of the dynamic connection (DC) between the destination device and the transmitting device; and
a second set of data packets received by the computing device after establishment of the dynamic connection (DC) between the destination device and the transmitting device.

19. The computer program product according to claim 18, wherein the first set of data packets further comprise a first data packet comprising one or more instructions for establishing the dynamic connection (DC) between the destination device and the transmitting device.

20. The computer program product according to claim 19, wherein the connect header for each of the data packets of the first set of data packets comprises one or more data entries for establishing the dynamic connection (DC).
